(19) United States
(12) Patent Application Publication
(10) Pub. No.: US 2007/0267063 A1
(43) Pub. Date: Nov. 22, 2007

(54) Unloader valve for pressurized fluid delivery system

(76) Inventor: Greg Davis, Jefferson, WI (US)

Correspondence Address: Michael Best & Friedrich LLP;Casimir F. Laska, Suite 3300, 100 East Wisconsin Avenue, Milwaukee, WI, 53202-4108, US

(21) Appl. No.: 11/804,253

(22) Filed: May 18, 2007

Related U.S. Application Data
(60) Provisional application No. 60/802,310, filed on May 22, 2006.

(51) Int. Cl. G05D 11/00

(52) U.S. Cl. 137/115.11

(57) ABSTRACT

A pressure washer system having a pump for pressurizing a fluid from a fluid source and selectively supplying pressurized fluid through a discharge line. The pressure washer system includes an unloader valve positioned between the pump and the discharge line. The unloader valve includes a fluid inlet, a discharge outlet, a bypass outlet, a first passageway establishing fluid communication between the fluid inlet and the discharge outlet in a first position of the unloader valve, and a second passageway establishing fluid communication between the fluid inlet and the bypass outlet in a second position of the unloader valve. The unloader valve is configured to maintain the pressurized fluid at the fluid inlet, the discharge outlet, and the bypass outlet at a substantially equal pressure when the unloader valve is in the second position.

### RELATED APPLICATION DATA

This application claims priority under 35 U.S.C. sec. 119 to provisional patent application No. 60/802,310, filed on May 22, 2006, which is hereby fully incorporated by reference.

### BACKGROUND

The present invention relates to an unloader arrangement for use with a pressurized fluid delivery system. More specifically, the invention relates to an unloader valve for a pressure washer system which is operable between spray mode and bypass mode.

### SUMMARY

In one embodiment, the invention provides a pressurized fluid delivery system having a pump for pressurizing a fluid from a fluid source and selectively supplying pressurized fluid through a discharge line to a system outlet. The pressurized fluid delivery system includes an unloader valve positioned between the pump and the system outlet. The unloader valve includes a fluid inlet, a discharge outlet, a bypass outlet, a first passageway establishing fluid communication between the fluid inlet and the discharge outlet in a first position of the unloader valve, and a second passageway establishing fluid communication between the fluid inlet and the bypass outlet in a second position of the unloader valve. The unloader valve is configured to maintain the pressurized fluid at the fluid inlet, the discharge outlet, and the bypass outlet at a substantially equal pressure when the unloader valve is in the second position.

In another embodiment, the invention provides a pressurized fluid delivery system including a pump operable to pressurize a fluid, a system outlet configured to selectively output a pressurized fluid, and an unloader valve including a fluid inlet. The unloader valve is configured to direct pressurized fluid to at least one of the discharge line and a return line. The discharge line is in fluid communication with a discharge outlet of the unloader valve. The return line provides fluid communication between a bypass outlet of the unloader valve and an inlet side of the pump. The unloader valve is configured to move between a bypass position and a spray position. The unloader valve is configured to maintain constant fluid communication between the fluid inlet and the discharge line.

In yet another embodiment, the invention provides a pressurized fluid delivery system having a pump configured to pressurize a fluid, and having a discharge valve to discharge a pressurized fluid through a system outlet. The pressurized fluid delivery system includes a return line configured to supply pressurized fluid back to an inlet side of the pump. An unloader valve of the pressurized fluid delivery system has a fluid inlet configured to receive pressurized fluid from the pump. The unloader valve is configured to establish fluid communication between the fluid inlet and the system outlet, and to selectively establish fluid communication between the fluid inlet and the return line. The unloader valve includes a shuttle configured to move between a bypass position and a spray position. The shuttle is configured to establish a bypass flow passage between the fluid inlet and the return line in the bypass position. The shuttle is actuable to the spray position by movement of the discharge valve from a closed position to an open position, in which open position the shuttle blocks the bypass flow passage. The shuttle is configured to provide constant fluid communication between the fluid inlet and the discharge outlet regardless of the position of the shuttle.

Other aspects of the invention will become apparent by consideration of the detailed description and accompanying drawings.

### BRIEF DESCRIPTION OF THE DRAWINGS

FIG. 1 is a side view of an unloader valve embodying the invention;

FIG. 2 is a front view of the unloader valve of FIG. 1;

FIG. 3 is a section view of the unloader valve taken along line A-A of FIG. 2;

FIG. 4 is a section view of the unloader valve taken along line B-B of FIG. 1;

FIG. 5 is a section view of a second unloader valve embodying the invention and taken along line A-A of FIG. 6;

FIG. 6 is a front view of the second unloader valve;

FIG. 7 is an exploded view of the second unloader valve;

FIG. 8 is an operational section view of the second unloader valve in bypass mode;

FIG. 9 is an operational section view of the second unloader valve in spray mode; and

FIG. 10 is a perspective view of a pressure washer system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Pressure washers provide a supply of high-pressure fluid for performing various tasks (e.g., paint and stain removal, drain cleaning, driveway cleaning, etc.). Sometimes the water is mixed with a cleaning solution such as soap, ammonia solution, or other chemicals to aid in the cleaning process.

Pressure washers and other pressurized fluid delivery systems often include an engine that drives a high-pressure pump to supply the fluid. A discharge valve (i.e., like a spray gun trigger valve) mounted to the discharge hose from the pump allows the user to remotely control the supply of high-pressure fluid. When the trigger or discharge valve is actuated, a fluid and/or cleaning solution is discharged. When the trigger is released, the flow of fluid stops and either the pump is disengaged, the engine is turned off, or the high-pressure fluid bypasses the outlet to avoid causing damage to the pressurized fluid delivery system. To that end, many pressurized fluid delivery systems include unloader valves that bypass the fluid back to a fluid reservoir or inlet side of the pump when the fluid is not being discharged.

Unloader valves, sometimes referred to as “bypass valves” or “diverter valves”, are used as a control mechanism for pressurized fluid delivery systems. The unloader valve controls the pressure and the direction of flow within the system. Located between the outlet side of the pump and the discharge valve, the unloader valve diverts fluid from the pump outlet back to the pump inlet through a bypass passage when the discharge passage becomes blocked (i.e. when the discharge valve is closed), thereby reducing pressure within the pump. When the discharge passage is unobstructed (i.e. when the discharge valve is open), the unloader valve redirects fluid back to the discharge device and allows the pump pressure to rise back to its normal operating pressure.

Most conventional unloader valves are designed with a high rate spring that will allow the opening of the unloader valve to the bypass position only with a relatively high trapped pressure between the unloader valve and the discharge or trigger valve. With most of these designs, this high-pressure value must be maintained (or “trapped”) within the discharge line and allowed communication against the high rate spring in order to keep the bypass open. If the “trapped line-pressure” is lowered due to leakage, hose expansion, etc., then the high rate unloader spring will close the bypass port in the unloader valve, which can result in pressure pulsations within the pump, engine stalls, or even pump, engine or hose damage.

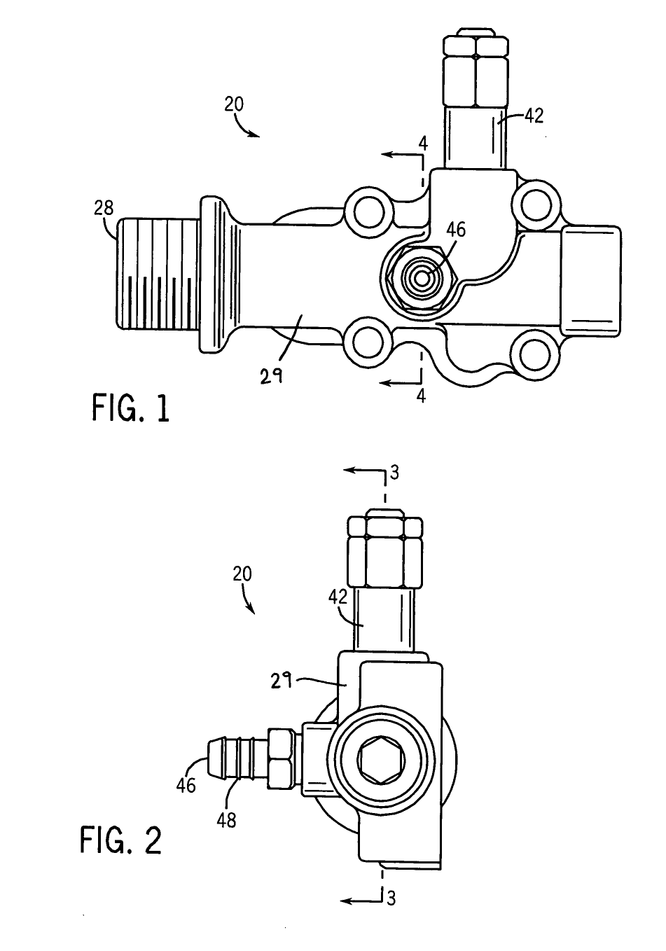

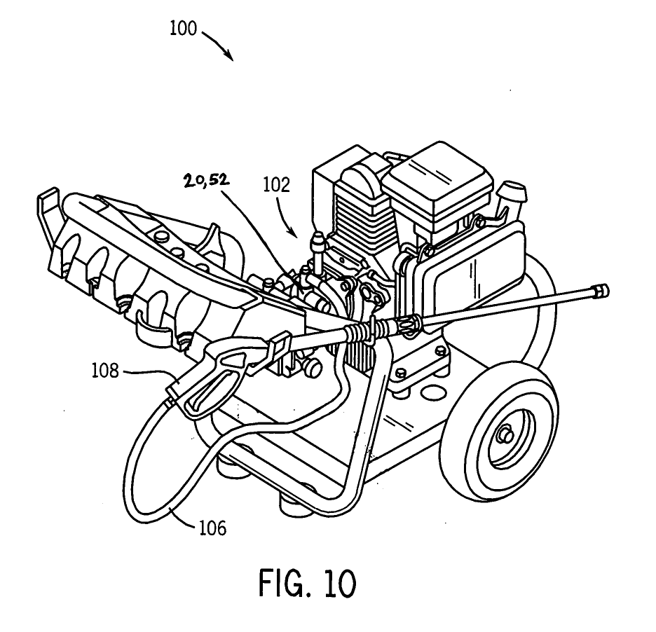

FIGS. 1-4 illustrate an unloader valve 20 for use with a pressurized fluid delivery system according to the invention, such as a pressure washer system 100 as shown in FIG. 10. The pressure washer system 100 generally includes an engine-driven pump 102, a fluid reservoir or other source from which the pump draws fluid, and a discharge line 106 terminating in a discharge valve such as that included in a hand-operated spray gun 108. The unloader valve 20 can be located between the spray gun 108 and a fluid outlet of the pump. The unloader valve 20 can be fluidly connected to both the pump outlet and the spray gun 108 by known methods including threaded connections, welding, compression fittings, and the like.

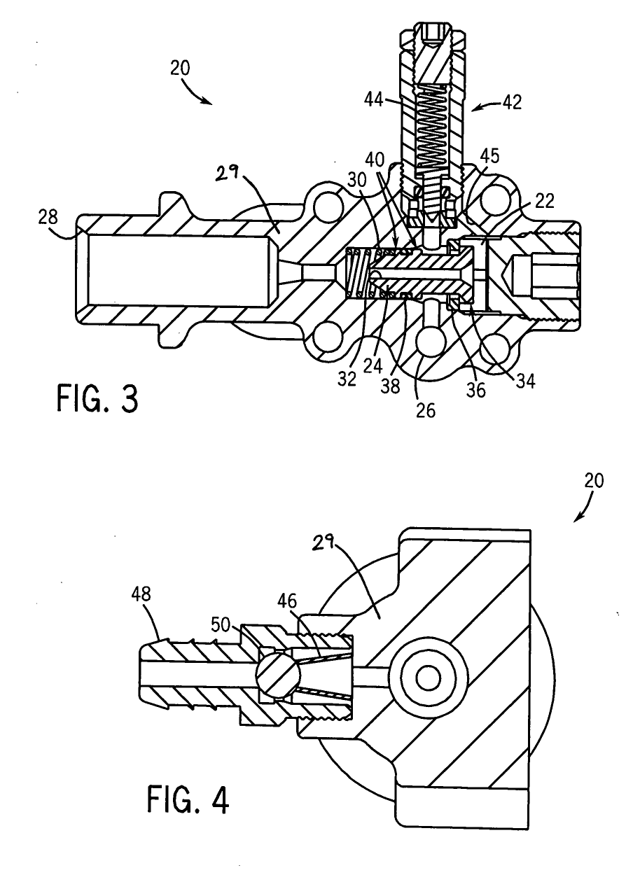

With reference to FIG. 3, the unloader valve 20 includes a fluid inlet 22, a shuttle 24, a bypass outlet 26, and a discharge outlet 28. The fluid inlet 22, the bypass outlet 26, and the discharge outlet 28 are all formed as part of a valve body 29 of the unloader valve 20. The fluid inlet 22 is configured to receive fluid from the pump 102 and deliver it to the shuttle 24. The shuttle 24 is biased to a bypass position with a spring 30. The shuttle 24 is provided with a fluid passage or port 32 therethrough. In the bypass position, the shuttle 24 allows fluid communication between the fluid inlet 22 and the bypass outlet 26 and more particularly between a sealing surface 34 of the shuttle 24 and a shuttle seat 36 positioned within the unloader valve 20. Therefore, pressurized fluid from the pump 102 is allowed to return via a return line to the upstream side of the pump 102 (e.g., the pump inlet). The return line can be integral with the pump 102 (e.g., integral with a housing of the pump 102) or provided as a separate conduit, such as a hose. In the bypass position, the shuttle 24 also allows fluid communication between the discharge outlet 28 of the unloader valve 20, the fluid inlet 22, and the bypass outlet 26 via the port 32 through the shuttle 24. An O-ring 38 positioned around the shuttle 24 provides a sliding seal between the shuttle 24 and an internal cavity of the valve body 29. The O-ring 38 is held in a groove formed by a pair of annular projections 40 on the shuttle 24.

Because the shuttle 24 of the unloader valve 20 does not block the discharge line 106 and spray gun 108 from the return line, high pressure fluid is not trapped in the discharge line 106 (i.e., between the trigger valve of spray gun 108 and the outlet 28 of the unloader valve 20). In fact, pressure in the discharge line 106 is not trapped and is not used to actuate the shuttle 24. Because the spring 30 biases the shuttle 24 to the bypass position, the “actuation” of the shuttle 24 in a direction from the bypass position toward a spray position is flow-triggered and occurs when the discharge valve of the spray gun 108 is open.

An integrated relief valve 42 is configured to open against the biasing force of a regulating spring 44 to relieve excess fluid pressure that may occur within the valve 20. This pressure relief reduces the likelihood of damage to the unloader valve 20 and/or other system components from exposure to excessive pressures. In the illustrated embodiment, an excess pressure port 45 is provided to fluidly connect the fluid inlet 22 to the bypass outlet 26 through the relief valve 42. The fluid inlet 22 and the bypass outlet 26 are otherwise separated from each other during operation when the valve 20 is in the spray position. Excess pressure relieved from the unloader valve 20 is contained within the system 100 and directed back to the fluid reservoir or pump inlet. In other constructions, excess pressure may be vented to the atmosphere or to another low pressure area other than the fluid source.

As illustrated in FIG. 4, the unloader valve 20 includes an injection port 46 for the addition of a secondary fluid, such as a cleaning chemical as described above, to the working fluid of the pressure washer system 100. In the illustrated embodiment, the injection port 46 includes a barbed portion 48 for attachment to a supply line such as a chemical supply hose. A check valve 50 is provided to prevent flow of fluid from the unloader valve 20 out through the injection port 46. This prevents damage to components upstream of the injection port 46 (e.g., chemical supply tank, hoses, valves, etc.) and also prevents the secondary fluid from being diluted or contaminated.

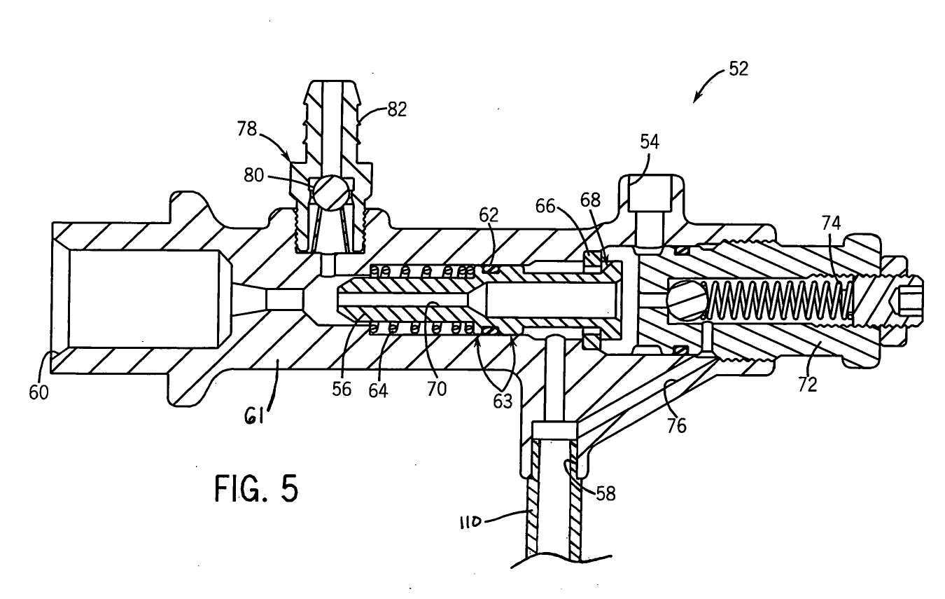

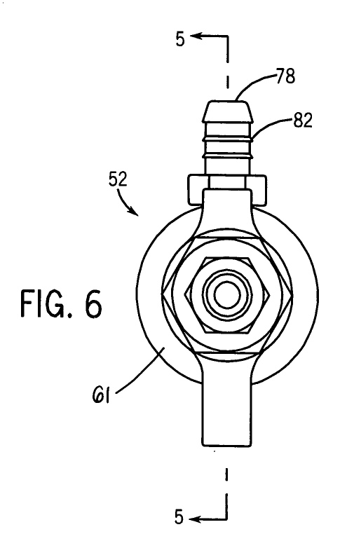

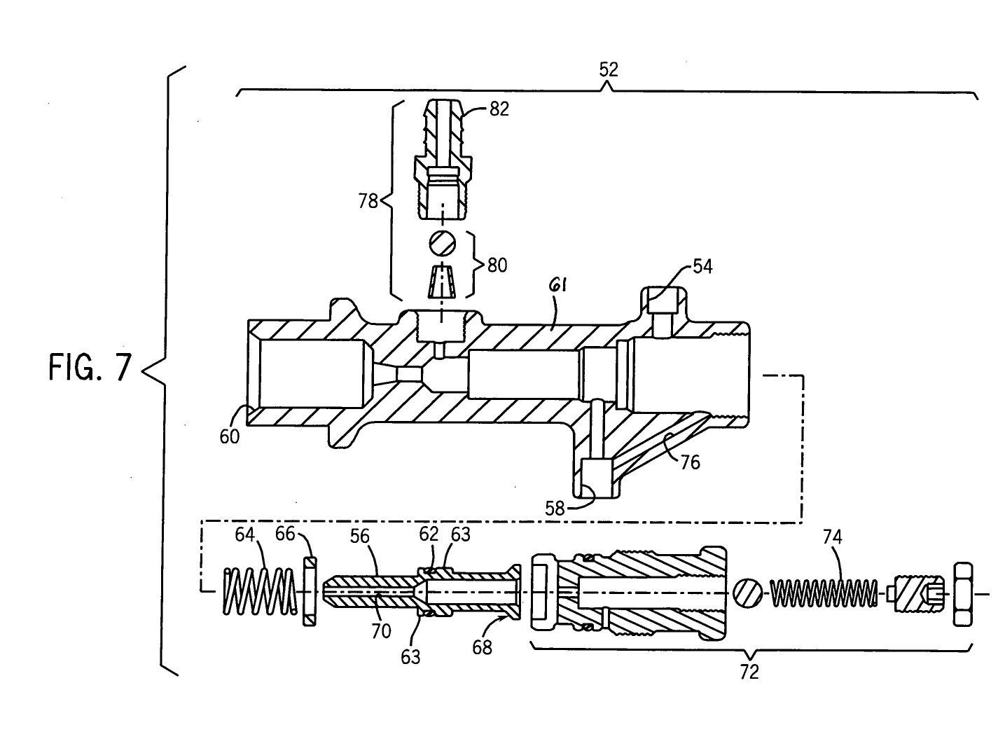

FIGS. 5-7 illustrate an unloader valve 52 of a second construction for use with the pressure washer system 100 or other pressurized fluid delivery system. The unloader valve 52 includes a fluid inlet 54, a shuttle 56, a bypass outlet 58, and a discharge outlet 60. The fluid inlet 54, the bypass outlet 58, and the discharge outlet 60 are all formed as part of a valve body 61 of the unloader valve 52. The shuttle 56 is movable between a bypass position and a spray position. An O-ring 62 is positioned around the shuttle 56 to provide annular sealing between the shuttle 56 and an interior cavity of the valve body 61, and to allow movement of the shuttle 56. The O-ring 62 is held in place by a pair of annular projections 63. A spring 64 biases the shuttle 56 to the bypass position. A shuttle seat 66 is positioned within the valve body 61 for contact with a sealing surface 68 of the shuttle 56 when the shuttle 56 is in the spray position.

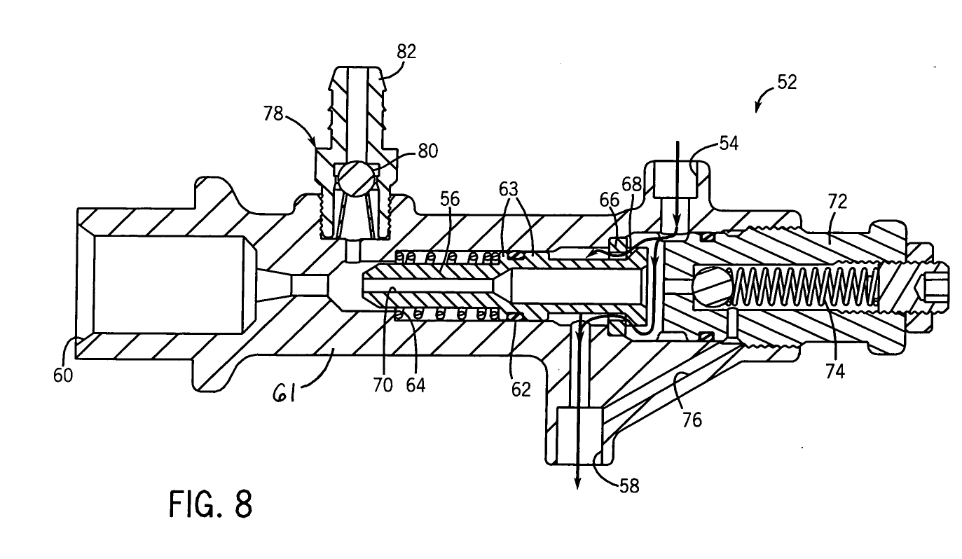

When in the bypass position, a space is created between the shuttle seat 66 and the sealing surface 68, which allows fluid to flow along a bypass fluid flow passageway from the fluid inlet 54 and around the shuttle 56 to the bypass outlet 58 (as shown with flow-indicating arrows in FIG. 8). Fluid provided to the bypass outlet 58 is routed back to a fluid reservoir or inlet side of the pump 102 via a return line 110 (as shown in FIG. 5). The return line 110 can be provided as part of the pump 102 (e.g., integral with a housing of the pump 102) or as a separate conduit such as a hose.

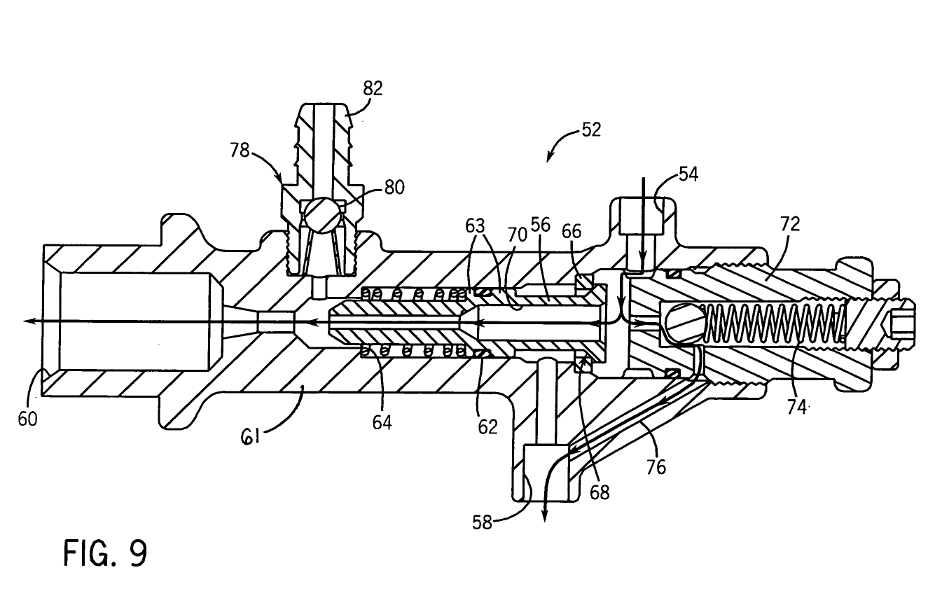

When in the spray position, the seal between the sealing surface 68 and the shuttle seat 66 inhibits the flow of fluid from the fluid inlet 54 to the bypass outlet 58. Thus, the working fluid can flow along a discharge fluid flow passageway from the fluid inlet 54, through a fluid passage or port 70 in the shuttle 56, and out the unloader valve 52 through the discharge outlet 60 (as shown with flow-indicating arrows in FIG. 9).

If a fluid pressure within the unloader valve 52 exceeds a predetermined relief pressure, an integrated relief valve 72 is configured to open against the biasing force of a regulating spring 74 to relieve the excess pressure. As described above, this reduces the likelihood of exposing the unloader valve 52 or other system components to excessive pressures. An excess pressure port 76 is provided in the valve 52 to fluidly connect the fluid inlet 54 to the bypass outlet 58 through the relief valve 72, which are otherwise separated from each other during operation when the valve 52 is in the spray position. FIG. 9 illustrates (with additional flow-indicating arrows) flow through the excess pressure port 76 during discharge of fluid. In other constructions, excess pressure may be vented to the atmosphere or to another low pressure area other than the fluid reservoir or pump inlet.

An injection port 78 is positioned adjacent a downstream side of the shuttle 56 for operation as described above with respect to the previous embodiment. The injection port 78 includes a check valve 80 and a projecting barbed portion 82 for connection to a hose or the like. The injection port 78 and the check valve 80 may be located on the unloader valve 52 in alternate constructions. Likewise, various methods of attachment known to those of skill in the art may be appropriate for connecting the injection port 78 to a secondary fluid supply.

In both illustrated embodiments, the unloader valve 20, 52 is biased to the bypass position and is actuable to the spray position. The valve 20, 52 is actuable to the spray position by a fluid pressure differential between the fluid inlet 22, 54 and the discharge outlet 28, 60, which acts against a relatively low bias force present in the spring 30, 64. The fluid pressure differential (present during periods of flow through the valve 20, 52) acts on a movable element, such as the shuttle 24, 56. More specifically, a distributed force acts on the movable element in the direction of the fluid flow through the valve 20, 52 when discharging from the spray gun 108 (parallel to an axis of the movable element in some embodiments). In some embodiments, fluid flows through at least one aperture in the movable element (e.g., through the port 32, 70). As illustrated, a reduction in cross-sectional area of the aperture in the movable element (in the direction of fluid flow during discharge from the spray gun 108) provides flow resistance in the form of additional surface area on which the net fluid pressure acts to urge the movable element to the spray position when the spray gun 108 is opened to create a pressure differential between the fluid inlet 22, 54 and the discharge outlet 28, 60. The construction and the configuration of the movable element within the valve 20, 52 place the discharge line 106 in fluid communication with the bypass outlet 26, 58 of the unloader valve 20, 52 when in the bypass position.

In the operation of the pressure washer system 100 having the unloader valve 20, 52, a user closes the discharge or trigger valve of the spray gun 108 when pressurized fluid is not desired to be discharged from the system 100. At that time, pressure builds up between the pump 102 and the spray gun 108, including in the unloader valve 20, 52. This pressure increase is mainly apparent at the discharge end (i.e., between the spray gun 108 and the unloader valve 20, 52) because the upstream end is maintained at high pressure during periods of use (i.e., operation of the pressure washer system 100 with the spray gun 108). When flow is stopped by the closing the discharge valve of the spray gun 108, the pressure differential between the fluid inlet 22, 54 and the discharge outlet 28, 60 of the unloader valve 20, 52 is virtually eliminated. Because the movable element is actuated to the spray position by the flow and requisite pressure differential, the movable element returns to the bypass position with only a small bias force once the flow is stopped. Pressurized fluid is maintained in the discharge line 106 during bypass, but is not trapped and may be maintained at a low pressure level because the pressure in the discharge line 106 is not used to keep the movable element in the bypass position. High pressure cannot build in the discharge line 106 because the discharge outlet 28, 60 is fluidly connected to the bypass outlet 26, 58 of the unloader valve 20, 52, which shunts the fluid flow to a low pressure area such as the fluid reservoir or pump inlet.

In the bypass position, the fluid inlet 22, 54 is in fluid communication with the bypass outlet 26, 58 and also with the discharge outlet 28, 60. Therefore, the pressure of the pressurized fluid at each of the three locations of the unloader valve 20, 52 is substantially equal. In the bypass position, pressurized fluid flows at least from the fluid inlet 22, 54 to the bypass outlet 26, 58, so there must be at least a minute pressure differential therebetween. However, due to the lack of a physical obstruction between the discharge outlet 28, 60 and either of the fluid inlet 22, 54 and the bypass outlet 26, 58, the pressurized fluid at the discharge outlet 28, 60 is maintained at a substantially equivalent pressure as that of the fluid inlet 22, 54 and the bypass outlet 26, 58.

What is claimed is:

1. A pressurized fluid delivery system having a pump configured to pressurize a fluid from a fluid source and to selectively supply the pressurized fluid through a system outlet, the pressurized fluid delivery system comprising:
an unloader valve positioned between the pump and the system outlet including
a fluid inlet,
a discharge outlet,
a bypass outlet,
a first passageway establishing fluid communication between the fluid inlet and the discharge outlet in a first position of the unloader valve, and
a second passageway establishing fluid communication between the fluid inlet and the bypass outlet in a second position of the unloader valve,
wherein the unloader valve is configured to maintain the pressurized fluid at the fluid inlet, the discharge outlet, and the bypass outlet at a substantially equal pressure when the unloader valve is in the second position.

2. The pressurized fluid delivery system of claim 1, further comprising a shuttle positioned inside the unloader valve and biased to a bypass position, the shuttle being configured to move to a spray position in response to a flow of pressurized fluid through the shuttle.

3. The pressurized fluid delivery system of claim 2, wherein the shuttle includes a sealing surface that is configured to move into and out of contact with a seat inside the unloader valve to respectively block and establish fluid communication between the fluid inlet of the unloader valve and the bypass outlet.

4. The pressurized fluid delivery system of claim 3, wherein the discharge outlet is in fluid communication with the fluid inlet in both the bypass position and the spray position of the shuttle.

5. The pressurized fluid delivery system of claim 2, further comprising a discharge valve that is configured to move between an open position and a closed position to respectively turn on and turn off the flow of pressurized fluid through the system outlet.

6. The pressurized fluid delivery system of claim 5, wherein the shuttle is configured to move from the bypass position to the spray position in response to the discharge valve being moved from the closed position to the open position.

7. The pressurized fluid delivery system of claim 1, further comprising a pressure relief valve integrated into the unloader valve and configured to move from a closed position to an open position when a pressurized fluid pressure is above a predetermined relief pressure.

8. The pressurized fluid delivery system of claim 7, wherein the unloader valve is configured to direct at least a portion of the pressurized fluid through the bypass outlet when the pressure relief valve is in the open position.

9. The pressurized fluid delivery system of claim 1, further comprising an injection port formed as part of the unloader valve and configured to supply a secondary fluid for mixing with the pressurized fluid.

10. The pressurized fluid delivery system of claim 1, further comprising a return line configured to direct pressurized fluid from the bypass outlet of the unloader valve to an inlet side of the pump.

11. A pressurized fluid delivery system comprising:
a pump operable to pressurize a fluid and having a discharge outlet;
a system outlet configured to selectively output a pressurized fluid from the system; and
an unloader valve including a fluid inlet and configured to direct pressurized fluid to at least one of the system outlet and a return line, the system outlet being in selective fluid communication with a discharge outlet of the unloader valve, the return line providing fluid communication between a bypass outlet of the unloader valve and an inlet side of the pump;
wherein the unloader valve is configured to move between a bypass position and a spray position, the unloader valve being configured to maintain constant fluid communication between the fluid inlet and the discharge outlet.

12. The pressurized fluid delivery system of claim 11, wherein the unloader valve includes a shuttle biased to a bypass position, the shuttle being configured to move to a spray position in response to flow of pressurized fluid therethrough.

13. The pressurized fluid delivery system of claim 12, wherein the shuttle is configured to move to the spray position when the discharge valve is opened to discharge the pressurized fluid.

14. The pressurized fluid delivery system of claim 12, wherein the shuttle includes a central aperture configured to establish fluid communication between the fluid inlet and the discharge outlet regardless of the position of the shuttle.

15. The pressurized fluid delivery system of claim 12, wherein the shuttle includes an outer surface at least partially defining a bypass flow passageway between the fluid inlet and the bypass outlet.

16. The pressurized fluid delivery system of claim 15, wherein the bypass flow passageway is blocked by a sealing surface of the shuttle when the shuttle is in the spray position.

17. The pressurized fluid delivery system of claim 11, further comprising a pressure relief valve integrated into the unloader valve and configured to move from a closed position to an open position in response to a pressurized fluid pressure above a predetermined relief pressure.

18. The pressurized fluid delivery system of claim 17, wherein the unloader valve includes a secondary bypass flow passage between the fluid inlet and the bypass outlet, the secondary bypass flow passage being at least partially defined by the pressure relief valve.

19. The pressurized fluid delivery system of claim 11, further comprising an injection port on the unloader valve, the injection port being configured to supply a secondary fluid for mixing with the pressurized fluid.

20. A pressurized fluid delivery system having a pump configured to pressurize a fluid and having a discharge valve to selectively discharge a pressurized fluid through a system output, the pressurized fluid delivery system comprising:
a return line configured to supply pressurized fluid from a discharge outlet of the pump back to an inlet side of the pump; and
an unloader valve having a fluid inlet configured to receive pressurized fluid from the pump, the unloader valve being configured to establish fluid communication between the fluid inlet and the discharge outlet and to selectively establish fluid communication between the fluid inlet and the return line, the unloader valve including a shuttle configured to move between a bypass position and a spray position, the shuttle being configured to establish a bypass flow passageway between the fluid inlet and the return line in the bypass position, the shuttle being actuable to the spray position by movement of the discharge valve from a closed condition to an open condition, in which open position the shuttle blocks the bypass flow passageway, wherein the shuttle is configured to provide constant fluid communication between the fluid inlet and the discharge outlet regardless of the position of the shuttle.

21. The pressurized fluid delivery system of claim 20, wherein an outer surface of the shuttle at least partially defines the bypass flow passageway.

22. The pressurized fluid delivery system of claim 20, further comprising a spring positioned within the unloader valve, the spring being configured to provide a biasing force biasing the shuttle to the bypass position.

23. The pressurized fluid delivery system of claim 22, wherein the biasing force of the spring is selected to provide a relatively light biasing force such that the biasing force of the spring is overcome by a fluid pressure differential across the shuttle when the pressurized fluid is flowing from the fluid inlet out the discharge outlet.

24. The pressurized fluid delivery system of claim 20, further comprising a pressure relief valve integrated with the unloader valve and configured to move from a closed position to an open position when the pressurized fluid within the unloader valve exceeds a predetermined relief pressure.

25. The pressurized fluid delivery system of claim 24, wherein a secondary bypass fluid passage is defined within the unloader valve, the secondary bypass fluid passage being configured to provide a flow of pressurized fluid between the fluid inlet and the return line, the secondary bypass fluid passage being at least partially defined by the pressure relief valve.
